(19) United States
(12) Patent Application Publication
(10) Pub. No.: US 2026/0198678 A1
(43) Pub. Date: Jul. 16, 2026

(54) POWERED CLEANING TOOL

(71) Applicant: TECHTRONIC CORDLESS GP, Anderson, SC (US)

(72) Inventors: Silas Wendell Holmes, III, Greenville, SC (US); John P. Troy, Pickens, SC (US); Julia Hershey Moylan, Easley, SC (US); John Christian Harris, Greenville, SC (US); Nicholas Scott Norton, Anderson, SC (US)

(21) Appl. No.: 19/016,853

(22) Filed: Jan. 10, 2025

(51) Int. Cl. A46B 13/02; B25G 1/04; B25G 3/38

(52) U.S. Cl. CPC A46B 13/02; B25G 1/04; B25G 3/38

(57) ABSTRACT

A powered cleaning tool includes a main housing, a drive assembly located within the main housing that has an electric motor with a motor shaft defining an output axis, and a transmission having at least one planetary stage for rotatably driving an output shaft in response to receiving torque from the motor shaft. The output shaft extends along the output axis. The powered cleaning tool further includes a battery receptacle at least partially located within the main housing that defines a battery insertion axis parallel to the output axis and is configured to receive a battery along the battery insertion axis to power the electric motor, a pole including a grip portion and a distal end, and a pivot joint rotatably coupling the main housing and the distal end of the pole defining a pivot axis about which the main housing is adjustable relative to the pole.

### FIELD OF THE INVENTION

The present invention relates to cleaning tools, and more particularly to powered cleaning tools.

### BACKGROUND OF THE INVENTION

Powered cleaning tools are typically implemented in a powered hand tool format where a user can grasp the hand tool to clean a surface close to themselves. However, for hard-to-reach surfaces, powered cleaning tools can include a cleaning tool head mounted to a rod for extending the cleaning tool head to different distances away from the user to clean hard-to-reach surfaces. Powered cleaning tools can be powered by a battery that is typically coupled to a grip portion of the rod.

### SUMMARY OF THE INVENTION

The present invention provides, in one aspect, a powered cleaning tool that includes a main housing, a drive assembly located within the main housing that has an electric motor with a motor shaft defining an output axis, and a transmission having at least one planetary stage for rotatably driving an output shaft in response to receiving torque from the motor shaft. The output shaft is configured to extend along the output axis. The powered cleaning tool further includes a battery receptacle at least partially located within the main housing that defines a battery insertion axis parallel to the output axis and is configured to receive a battery along the battery insertion axis to power the electric motor, a pole including a grip portion and a distal end, and a pivot joint rotatably coupling the main housing and the distal end of the pole defining a pivot axis about which the main housing is adjustable relative to the pole.

The present invention provides, in another aspect, a powered cleaning tool that includes a main housing, an electric motor located within the main housing having a motor shaft defining an output axis, and a battery receptacle at least partially located in the main housing defining a battery insertion axis parallel to the output axis and configured to receive a battery along the battery insertion axis to power the electric motor. The powered cleaning tool further includes a pole including a grip portion and a distal end defining a longitudinal axis therebetween, a pivot joint rotatably coupling the main housing and the distal end of the pole defining a pivot axis about which the main housing is adjustable relative to the pole. The longitudinal axis is oriented perpendicular to and intersects the pivot axis.

The present invention provides, in yet another aspect, a powered cleaning tool that includes a main housing, a drive assembly located within the main housing having an electric motor, a motor bracket in which the electric motor is at least partially received, and a transmission having a transmission housing and at least one planetary stage within the transmission housing for rotatably driving an output shaft in response to receiving torque from the electric motor. The powered cleaning tool further includes a bayonet arrangement interconnecting the transmission housing to the motor bracket to rotationally affix the transmission housing to the motor bracket, a key/keyway arrangement interconnecting the motor bracket to the main housing to rotationally affix the motor bracket to the main housing, and a battery receptacle at least partially located in the main housing defining a battery insertion axis parallel to the output shaft and configured to receive a battery along the battery insertion axis to power the electric motor.

Other features and aspects of the invention will become apparent by consideration of the following detailed description and accompanying drawings.

### BRIEF DESCRIPTION OF THE DRAWINGS

FIG. 1 is a perspective view of a powered cleaning tool.

FIG. 2 is an enlarged perspective view of a cleaning tool head of the powered cleaning tool of FIG. 1.

FIG. 3 is a cross-sectional view of the cleaning tool head of FIG. 2, along section line 3-3 in FIG. 2, oriented in a first position about a pivot axis relative to a pole.

FIG. 4 is a cross-sectional view of the cleaning tool head of FIG. 3 oriented in an intermediate position about the pivot axis relative to the pole.

FIG. 5 is side view of the cleaning tool head of FIG. 3 oriented in a second position about the pivot axis relative to the pole.

FIG. 6 is an exploded perspective view of a main housing of the cleaning tool head of FIGS. 2-5 .

FIG. 7 is an exploded perspective view of the main housing of FIG. 6 with portions removed for clarity.

FIG. 8A is a perspective view of a first mounting arrangement between a transmission housing and a motor bracket.

FIG. 8B is an additional perspective view of the first mounting arrangement of FIG. 8A.

FIG. 9A is rear view of the interior of the main housing of FIGS. 6 and 7, illustrating the transmission housing and motor bracket assembled to the main housing.

FIG. 9B is a rear perspective view of the main housing of FIG. 9A.

FIG. 10 is an exploded perspective view of a pivot joint of the powered cleaning tool of FIG. 1.

FIG. 11 is a cross-sectional view of a telescoping pole of the powered cleaning tool of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

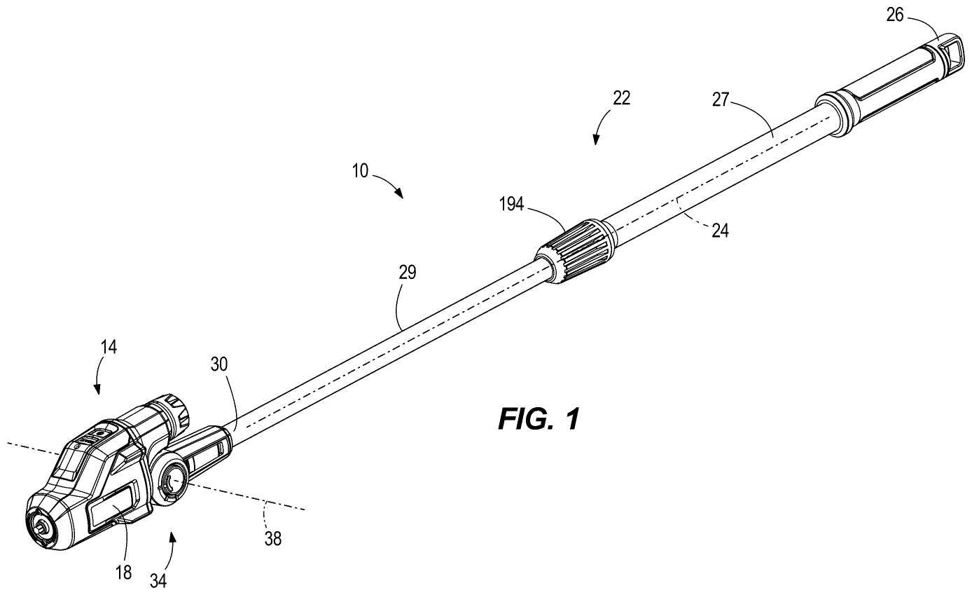

FIG. 1 illustrates a powered cleaning tool 10 including a cleaning tool head 14 defining a main housing 18, a telescoping pole 22 extending along a longitudinal axis 24 having a grip portion 26 for a user to grasp, and a distal end 30 opposite the grip portion 26, and a pivot joint 34 rotatably coupling the distal end 30 of the telescoping pole 22 to the main housing 18. The pivot joint 34 defines a pivot axis 38 about which the main housing 18 is adjustable relative to the pole 22. The longitudinal axis 24 is oriented such that it is perpendicular to and intersects the pivot axis 38.

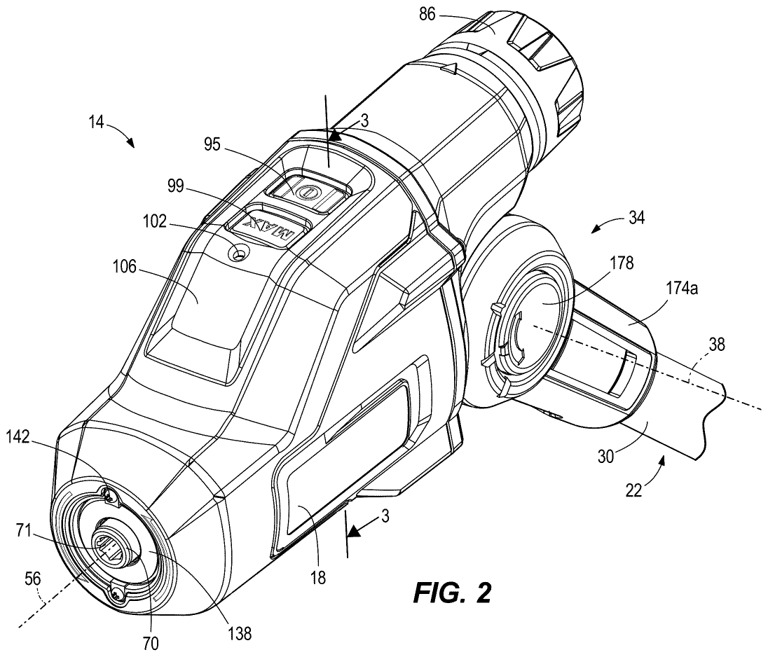

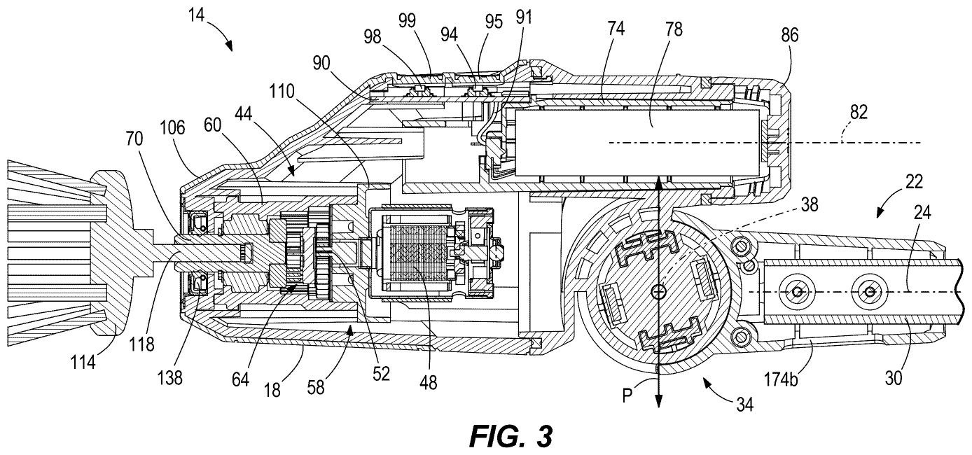

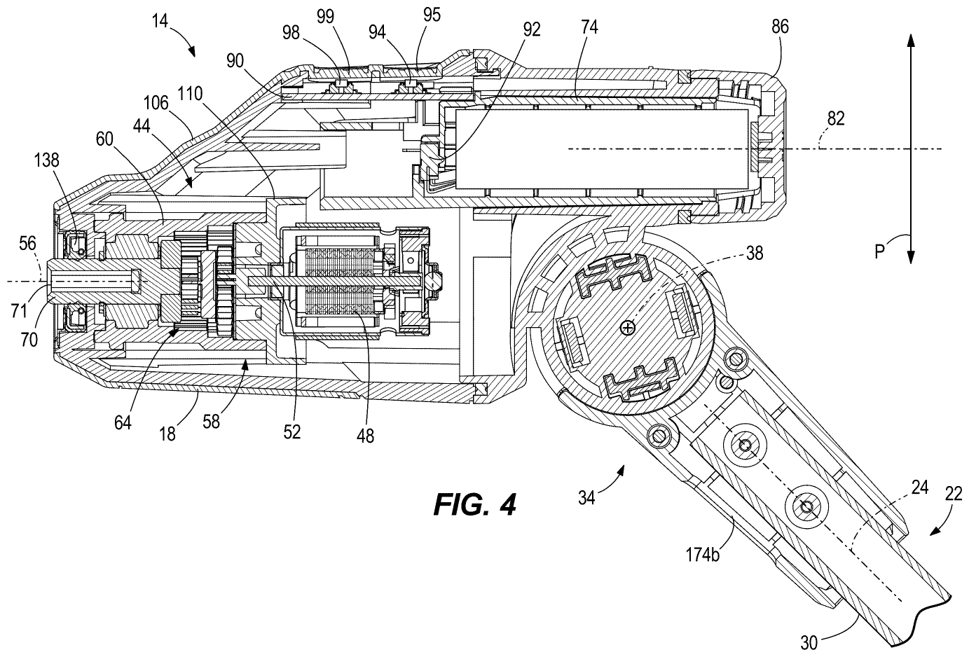

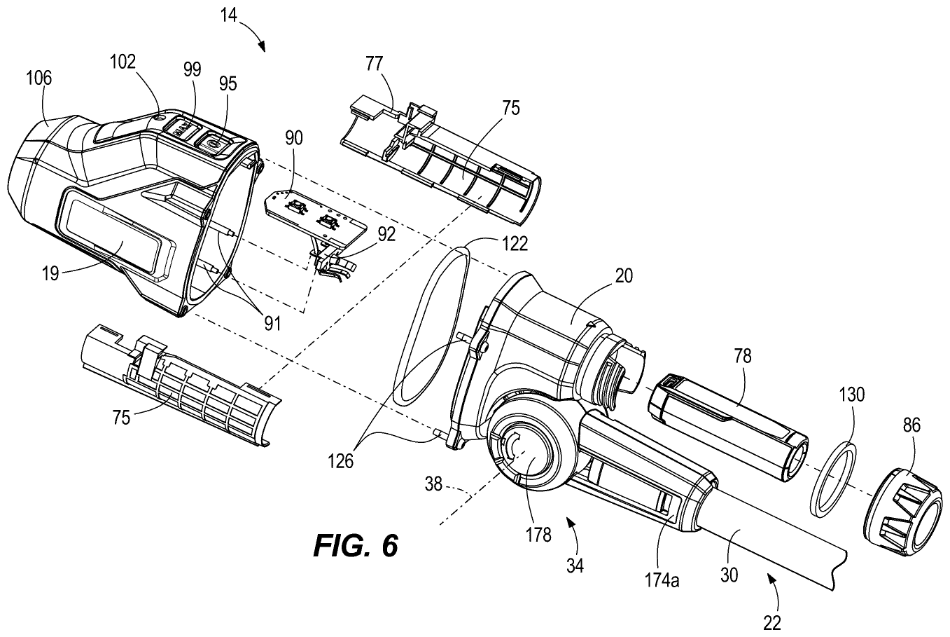

FIGS. 2-4 illustrate the cleaning tool head 14 of the powered cleaning tool 10. The main housing 18 of the tool head 14 includes a drive assembly 44 (FIG. 3) located within the main housing 18 having an electric motor 48 with a motor shaft 52 defining an output axis 56 (FIGS. 2, 4). The drive assembly 44 further includes a transmission 58 having a transmission housing 60 and one or more planetary gear stages 64 for rotatably driving an output shaft 70 extending along the output axis 56 in response to receiving torque from the motor shaft 52. The main housing 18 further includes a battery receptacle 74 partially located in the main housing 18 adjacent (i.e., above) the pivot joint 34. The battery receptacle 74 is formed by two half clamshells 75 (FIG. 6) that when unitized retain a battery 78 therein. The battery 78 provides electrical current to the electric motor 48 when activated. The battery receptacle 74 defines a battery insertion axis 82 that is parallel to the output axis 56, and the receptacle 74 is configured to receive the battery 78 along the insertion axis 82 (FIG. 4). To retain the battery 78 in the receptacle 74, the main housing 18 further includes an end cap 86 threaded to the housing 18 that a user must first remove, and subsequently replace when the user is inserting or removing the battery 78 from the receptacle 74. In some embodiments, the battery 78 includes a single cell having a voltage of 4 Volts.

With continued reference to FIGS. 2-4 , the main housing 18 further includes a printed circuit board assembly or PCBA 90 having a plurality of switches, such as a motor control switch 94 for activating and deactivating the electric motor 48, and a speed selection switch 98 for increasing a rotational speed of the motor 48, and a work light 102 (e.g., an LED) configured to illuminate a cleaning surface for the user whenever the motor control switch 94 is activated. Each of the switches 94, 98 has a corresponding button 95, 99 that the user can selectively depress to actuate the desired switch 94, 98. The buttons 95, 99 are located on an elastomeric (e.g., rubber) overmold portion 106 of the main housing 18. The main housing 18 further includes a motor bracket 110 for securing the electric motor 48 to the main housing 18. The motor bracket 110 interconnects between the transmission housing 60 and the main housing 18 in an arrangement that is described below. In some embodiments, the work light 102 is configured to illuminate a green color during normal operating conditions, a solid red color when the battery 78 reaches a charge level between 5-25% of a remaining charge capacity, and flash red when the powered cleaning tool 10 enters a plurality of different protections, or the battery 78 reaches a charge level between 0-5% of the remaining charge capacity.

With reference to FIG. 3, the cleaning tool head 14 of the powered cleaning tool 10 is configured to receive one or more cleaning tool accessories 114. Each of the cleaning tool accessories 114 includes a shank 118 that is received within a non-circular (e.g., hexagonal) bore 71 (FIG. 2) of the output shaft 70 of the tool head 14 for co-rotation therewith.

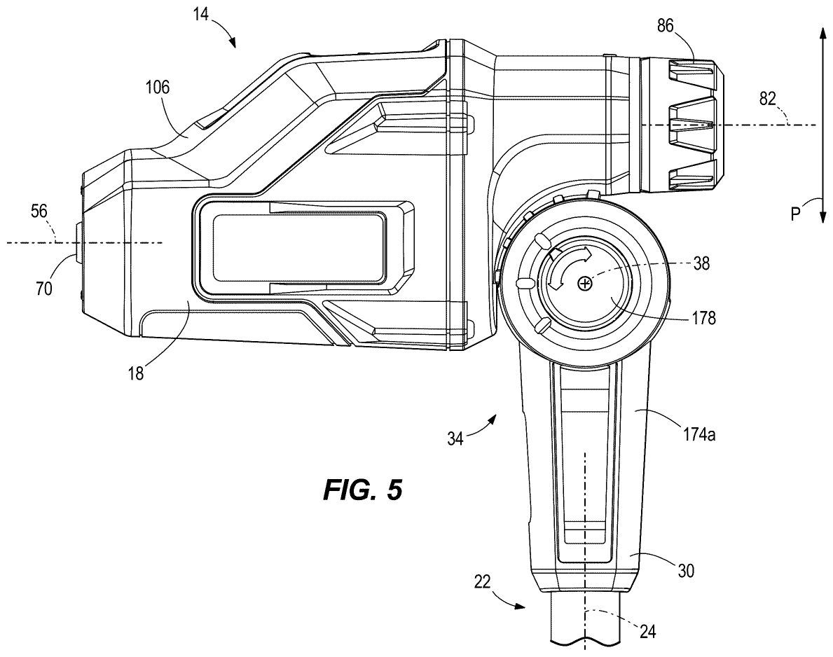

FIGS. 3-5 illustrate the main housing 18 of the cleaning tool head 14 adjustable about the pivot axis 38 between a plurality of different positions relative to the pole 22. The main housing 18 is adjustable about the pivot axis 38 between a first position (FIG. 3), an intermediate position (FIG. 4), and a second position (FIG. 5). In the first position, the longitudinal axis 24 of the pole 22 is parallel to the battery insertion axis 82. When the main housing 18 is moved to the intermediate position, the longitudinal axis 24 of the pole is transverse or obliquely oriented to the battery insertion axis 82. The intermediate position encompasses any rotational position of the housing 18 about the pivot axis 38 relative to the pole 22 between the first and second positions. In the second position, the longitudinal axis 24 of the pole 22 is perpendicular to the battery insertion axis 82. In some embodiments, when the main housing 18 is oriented about the pivot axis 38 in the first position, a reference plane P perpendicular to both the longitudinal axis 24 of the pole 22 and the output axis 56, and containing the pivot axis 38 as shown in FIG. 3, intersects the battery receptacle 74. As shown in FIG. 3, the reference plane P is also oriented perpendicular to the battery insertion axis 82.

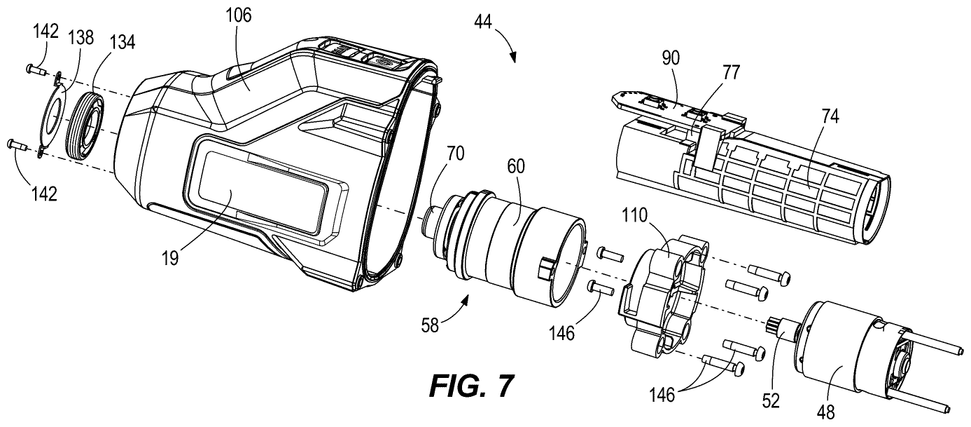

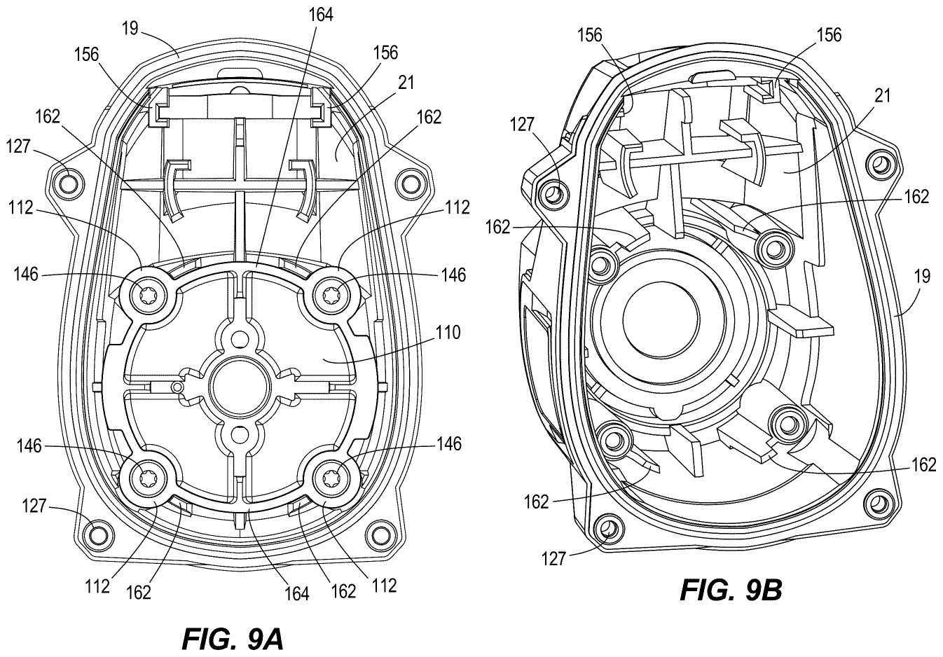

FIGS. 6 and 7 illustrate exploded perspective views of the tool head 14, with the main housing 18 further separated into a front main housing portion 19 and a rear main housing portion 20 secured together by a plurality of fasteners 126 received in corresponding apertures 127 (FIG. 9A) on the front main housing portion 19. Between the main housing portions 19, 20 is a gasket 122 for sealing the main housing portions 19, 20. The front main housing portion 19 receives the drive assembly 44 as further described below. The front and rear main housing portions 19,20, in tandem, support the battery receptable 74 and battery 78. The battery receptacle 74 includes a mount 77 to which the PCBA 90 is retained (FIG. 7). The PCBA 90 is electrically connected to the electric motor 48 via a plurality of electrical connections 91 (e.g., wires; FIG. 6). The PCBA 90 is also electrically connected to a terminal block 92, which is supported within the battery receptacle 74 for connection to the battery 78. To seal the rear main housing portion 20 and the battery receptacle 74, a seal ring 130 is disposed between the end cap 86 and the rear main housing portion 20. Additionally, the rear main housing portion 20 is rotatably coupled to the pivot joint 34 for rotation about the pivot axis 38 relative to the pole 22.

FIG. 7 illustrates the front main housing portion 19 and its internal components. The front main housing portion 19 supports the drive assembly 44 including the transmission housing 60, and partially supports the battery receptacle 74 and battery 78. Additionally, the front main housing portion 19 partially supports the PCBA 90 on a plurality of ribs 156 (FIGS. 9A, 9B) formed in a cavity 21 of the front main housing portion 19. The motor bracket 110 is secured to the front main housing portion 19 via a plurality of fasteners 146 (e.g., screws) that extend through respective apertures 112 on the motor bracket 110, as well as other interconnections as described below. The electric motor 48 is secured to the motor bracket 110 via the plurality of fasteners 146. The front main housing portion 19 further includes a lubricant seal ring 134 surrounding the output shaft 70 for sealing lubricant within the transmission housing 60, and a retaining plate 138 secured to the front main housing portion 19 with a plurality of fasteners 142 (e.g., screws) for securing the lubricant seal ring 134 in the front main housing portion 19.

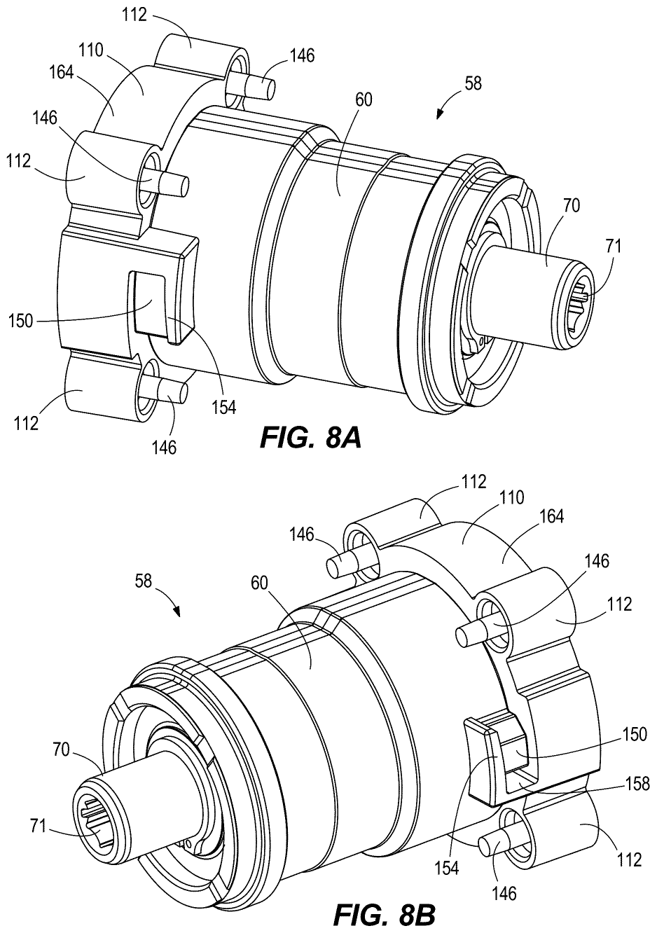

FIGS. 8A-8B illustrate a first mounting arrangement interconnecting the transmission housing 60 and the motor bracket 110. The first mounting arrangement includes a radial protrusion 150 formed on opposite sides of an outer surface of the transmission housing 60 received within a receptor 154 defining a slot 158 (FIG. 8B) that is formed on opposite sides of the motor bracket 110 and extending outward therefrom. Respective radial protrusions 150 are received in respective slots 158 on opposite sides of the motor bracket 110 in form of a bayonet mounting arrangement. The bayonet mounting arrangement interconnects the transmission housing 60 and the motor bracket 110 to rotationally affix the transmission housing 60 to the motor bracket 110.

FIGS. 9A-9B illustrate a second mounting arrangement interconnecting the motor bracket 110 and the front main housing portion 19. The second mounting arrangement includes a key 162 (FIG. 9B) formed on the inner cavity 21 of the front main housing portion 19 and extending outward therefrom, and a keyway 164 defined between apertures 112 on opposite sides of motor bracket 110. The keyway 164 is configured to receive the key 162. The key 162 and keyway 164 arrangement interconnects the motor bracket 110 to the front main housing portion 19 to rotationally affix the motor bracket 110 (and therefore the transmission housing 60) to the front main housing portion 19.

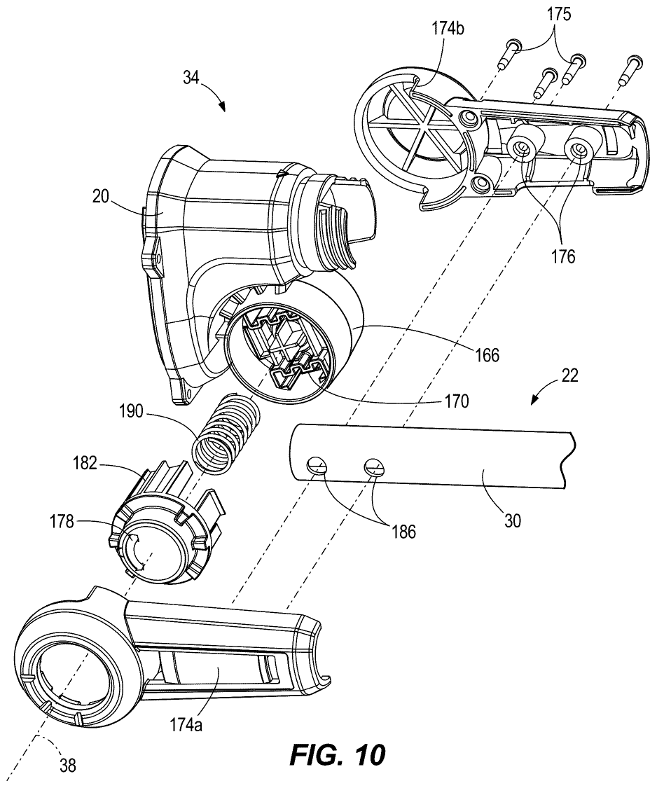

FIG. 10 illustrates the pivot joint 34 of the powered cleaning tool 10. The pivot joint 34 includes a pivot hub 166 coupled to the rear main housing portion 20 having a plurality of ribs 170, first and second pivot housing portions 174a, 174b disposed on opposite sides of the pivot hub 166, and a pivot button 178 supported in the first pivot housing portion 174a having a locking geometry 182 configured to enmesh with the plurality of ribs 170 in the pivot hub 166. The first and second pivot housing portions 174a, 174b are fastened to the distal end 30 of the pole 22 via a plurality of fasteners 175 that extend through apertures 176 located on the second pivot housing portion 174b and corresponding apertures 186 located on the distal end 30 of the pole 22. The pivot joint 34 further includes a biasing member 190 (e.g., a compression spring) that biases the locking geometry 182 of the pivot button 178 into engagement with the plurality of ribs 170 located on the pivot hub 166 to lock the main housing 18 in one of the various positions (FIGS. 3-5) about the pivot axis 38 relative to the pole 22.

To adjust the main housing 18 about the pivot axis 38 relative to the pole 22, a user presses the pivot button 178 against the bias of the biasing member 190, which disengages the locking geometry 182 of the pivot button 178 from the ribs 170 on the pivot hub 166, and rotates the main housing 18 to the desired position about the pivot axis 38. Next, the user releases the button 178, which re-engages the locking geometry 182 with the ribs 170 on the pivot hub 166 to again lock the main housing 18 in place. In the illustrated embodiment, the main housing 18 is pivotable about the pivot axis 38 up to 90 degrees relative to the pole 22.

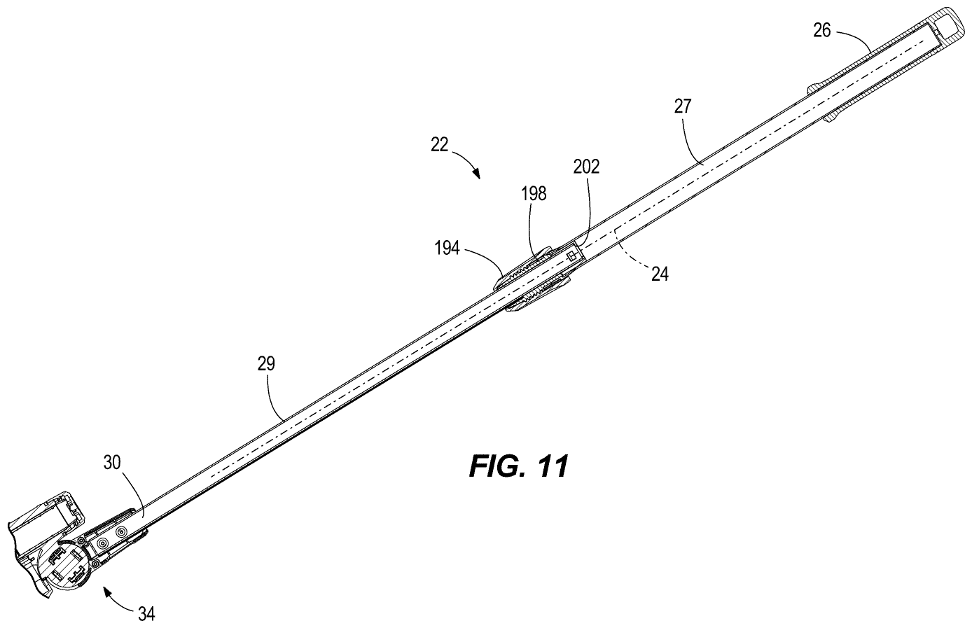

FIG. 11 illustrates the telescoping pole 22 for the user to use to manipulate the cleaning tool head 14. The telescoping pole 22 includes a first segment 27 having the grip portion 26 and a separate, second segment 29 having the distal end 30 that is slidably adjustable relative to the first segment 27 of the pole 22 to be received therein. The first and second segments 27, 29 are coupled by a pole connector 194 having an inner pole connector 198 for engagement with a telescoping stopper 202 on the first segment 27. To retract the second segment 29 within the first segment 27 of the pole 22, and therefore retract the cleaning tool head 14 relative to the first segment 27, the user twists the pole connector 194 about the longitudinal axis 24, thereby moving the inner pole connector 198 out of engagement with telescoping pole stopper 202, and slides the second segment 29 into the first segment 27 to the desired length. Next, the user then twists the pole connector 194 the opposite direction about the longitudinal axis 24 to engage the inner pole connector 198 with the telescoping pole stopper 202 to lock the second segment 29 in place. To extend the second segment 29 out from the first segment 27 of the pole 22, the user completes the above steps in the opposite order.

By utilizing the first and second mounting arrangements for interconnecting the motor bracket 110, the transmission housing 60, and the main housing 18, the assembly of the powered cleaning tool 10 is simplified. Similarly, having the PCBA 90 supported by the battery receptacle 74 and within the main housing 18 via the plurality of ribs 156, several fasteners are removed from the assembly of the powered cleaning tool 10. Both of these improvements reduce the overall cost of the tool 10.

In addition, by locating the battery 78 within the cleaning tool head 14 rather than the grip portion 26 of the pole 22, as many conventional powered cleaning tools currently practice, the user can more easily articulate and handle the powered cleaning tool 10 when trying to reach hard-to-reach cleaning surfaces. Similarly, by locating the buttons 95, 99 on top of the front housing 18, the user can more conveniently access the buttons 95, 99 when positioning the main housing 18 in one of the various positions about the pivot axis 38.

Various features of the invention are set forth in the following claims.

What is claimed is:

1. A powered cleaning tool comprising:
a main housing;
a drive assembly located within the main housing, the drive assembly including
an electric motor having a motor shaft defining an output axis,
a transmission having at least one planetary stage for rotatably driving an output shaft in response to receiving torque from the motor shaft, the output shaft extending along the output axis;
a battery receptacle at least partially located within the main housing and defining a battery insertion axis parallel to the output axis, the battery receptacle configured to receive a battery along the battery insertion axis to power the electric motor;
a pole including a grip portion and a distal end; and
a pivot joint rotatably coupling the main housing and the distal end of the pole, the pivot joint defining a pivot axis about which the main housing is adjustable relative to the pole.

2. The powered cleaning tool of claim 1, wherein the pivot axis is transverse to the output axis.

3. The powered cleaning tool of claim 1, wherein the battery receptacle is adjacent the pivot joint.

4. The powered cleaning tool of claim 1, wherein the pivot joint is between the distal end of the pole and the main housing.

5. The powered cleaning tool of claim 1, wherein the pole includes a first segment having the grip portion and a separate, second segment that is slidably adjustable relative to the first segment of the pole, and wherein the distal end is on the second segment.

6. The powered cleaning tool of claim 1, wherein the pole defines a longitudinal axis.

7. The powered cleaning tool of claim 6, wherein the main housing is adjustable between a first position where the longitudinal axis of the pole is transverse to the battery insertion axis, and a second position where the longitudinal axis is parallel to the battery insertion axis.

8. The powered cleaning tool of claim 1, further comprising:
at least one cleaning tool accessory removably coupled to the output shaft for co-rotation therewith.

9. The powered cleaning tool of claim 1, wherein the transmission further includes a transmission housing in which the at least one planetary stage is received, and wherein the powered cleaning tool further comprises:
a motor bracket in which the electric motor is at least partially received;
a bayonet arrangement interconnecting the transmission housing to the motor bracket to rotationally affix the transmission housing to the motor bracket; and
a key/keyway arrangement interconnecting the motor bracket to the main housing to rotationally affix the motor bracket to the main housing.

10. A powered cleaning tool comprising:
a main housing;
an electric motor located within the main housing and including a motor shaft defining an output axis;
a battery receptacle at least partially located in the main housing defining a battery insertion axis parallel to the output axis, the battery receptacle configured to receive a battery along the battery insertion axis to power the electric motor;
a pole including a grip portion and a distal end defining a longitudinal axis therebetween; and
a pivot joint rotatably coupling the main housing and the distal end of the pole, the pivot joint defining a pivot axis about which the main housing is adjustable relative to the pole,
wherein the longitudinal axis is perpendicular to and intersects the pivot axis.

11. The powered cleaning tool of claim 10, wherein the main housing is adjustable to a first position where the longitudinal axis of the pole is parallel to the battery insertion axis, and in the first position, a reference plane perpendicular to both the longitudinal axis and the output axis intersects the battery receptacle.

12. The powered cleaning tool of claim 11, wherein the reference plane is perpendicular to the battery insertion axis in the first position.

13. The powered cleaning tool of claim 11, wherein the main housing is pivoted about the pivot axis 90 degrees relative to the pole when the main housing is adjusted from the first position to a second position.

14. The powered cleaning tool of claim 10, wherein the pivot joint is between the distal end of the pole and the main housing.

15. The powered cleaning tool of claim 10, further comprising:
a transmission having at least one planetary stage for rotatably driving an output shaft in response to receiving torque from the motor shaft, the output shaft extending along the output axis.

16. A powered cleaning tool comprising:
a main housing;
a drive assembly located within the main housing, the drive assembly including
an electric motor,
a motor bracket in which the electric motor is at least partially received, and
a transmission having a transmission housing and at least one planetary stage within the transmission housing for rotatably driving an output shaft in response to receiving torque from the electric motor;
a bayonet arrangement interconnecting the transmission housing to the motor bracket to rotationally affix the transmission housing to the motor bracket;
a key/keyway arrangement interconnecting the motor bracket to the main housing to rotationally affix the motor bracket to the main housing; and
a battery receptacle at least partially located in the main housing defining a battery insertion axis parallel to the output shaft, the battery receptacle configured to receive a battery along the battery insertion axis to power the electric motor.

17. The powered cleaning tool of claim 16, further comprising:
a pole including a grip portion and a distal end; and
a pivot joint rotatably coupling the main housing and the distal end of the pole, the pivot joint defining a pivot axis about which the main housing is adjustable relative to the pole.

18. The powered cleaning tool of claim 17, wherein the pole defines a longitudinal axis.

19. The powered cleaning tool of claim 18, wherein the main housing is adjustable between a first position where the longitudinal axis of the pole is transverse to the battery insertion axis, and a second position where the longitudinal axis is parallel to the battery insertion axis.

20. The powered cleaning tool of claim 17, wherein the pivot joint is between the distal end of the pole and the main housing.
